(19) United States
(12) Patent Application Publication
(10) Pub. No.: US 2026/0142213 A1
(43) Pub. Date: May 21, 2026

(54) FLOW BATTERY

(71) Applicant: ineova Corp., Akishima city, Tokyo (JP)

(72) Inventor: Masayuki Inokuchi, Akishima city, Tokyo (JP)

(73) Assignee: ineova Corp., Akishima city, Tokyo (JP)

(21) Appl. No.: 19/485,104

(22) PCT Filed: May 17, 2023
(86) PCT No.: PCT/JP2023/018496

§ 371 Date: Nov. 17, 2025

(51) Int. Cl. H01M 8/2485; H01M 8/0273; H01M 8/04007; H01M 8/04276; H01M 8/04313; H01M 8/18; H01M 8/2404; H01M 8/249

(52) U.S. Cl. CPC H01M 8/2485; H01M 8/0273; H01M 8/04007; H01M 8/04283; H01M 8/04313; H01M 8/18; H01M 8/2404; H01M 8/249

(57) ABSTRACT

[Problem] The purpose of the present invention, taking into consideration the disadvantages of conventional cell stack structures, is to provide a flow battery that resolves these disadvantages, typically an RF battery. [Solution] This flow battery is obtained by constructing a cell stack from a plurality of cell-cartridges that can be inserted and removed. The cell-cartridges each comprise a plurality of cells. In each of the cells, electrodes are connected at low resistance due to small binding force, and leakage of an electrolyte is prevented. Moreover, this flow battery comprises: a plurality of the cell-cartridges; and a backplane that attaches the plurality of cell-cartridges with gaps therebetween so that the cell-cartridges can be physically inserted and removed in a side-by-side state. By providing a rack or unit in which a plurality of the backplanes are mounted and providing an electrolyte tank that can be attached and detached, the invention makes it possible to freely design and change the output and the capacity of the flow battery in accordance with demand.

### TECHNICAL FIELD

The present invention is referred to as a flow battery, typically a redox flow battery (hereinafter referred to as “RF battery”).

### BACKGROUND ART

Hereinafter, an RF battery will be described as an example with respect to a flow battery.

The utilization of renewable energy such as solar ray, wind power ant others are promoted. Since the output of the solar power generation and wind power generation varies depending on the day and night, the weather, and the environment, a problem that the power system is disturbed occurs (power quality is reduced) when the solar power generation or wind power generation is introduced into the power system.

Therefore, an RF battery is attracting attention as a power storage battery (secondary battery) that is an element technology for for power grid stabilization. The RF battery has excellent characteristics in terms of long life, scalability to large capacities, and safety.

FIG. 1 is a diagram illustrating a basic structure of a conventional RF battery. Basically, the RF battery 100 is composed of a centrally located cell stack 101, and, arranged on both sides thereof, a positive electrolyte tank 102t and positive electrolyte circulation pump 102p and a negative-electrolyte tank 103t and negative-electrolyte circulation pump 103p. The positive electrode liquid feed pump 102p circulates the positive electrode liquid stored in the positive electrode liquid tank 102t through piping as indicated by a solid line. Similarly, the negative-electrolyte circulation pump 103p circulates the negative-electrolyte stored in tank 103t through piping as indicated by a dashed line.

The cell stack 101 is a cell stack structure in which a large number of battery cells 104 are stacked. Each battery cell 104 includes two cell frames 104sf and is sandwiched on both sides by electrode plates 104bp. Between the two cell frames 104sf are arranged a negative electrode 104ne, a separator 104se, and a positive electrode 104pe. The stacked battery cells 104 are sandwiched on both sides by electrode plates 108 and further sandwiched on both sides by end plates 105. The two end plates 105 are tightly bonded together along their periphery by fasteners (bolts and nuts) 106. Between the two cell frames 104sf of each battery cell, sealing material 107 is disposed along the cell frame edges to seal so that electrolytes (positive and negative electrolyte) do not leak. The cell-stack structure integrates the multiple battery cells 104 by clamping with end plates 105 and fasteners 106.

Such a cell-stack structure is a simple stacked structure of battery cells, and the mechanisms for supplying and returning electrolytes to the battery cells are also relatively simple. As a result, RF batteries with the cell-stack structure have relatively few parts, and material and manufacturing costs are relatively low.

### PRIOR ART DOCUMENT

### Patent Literature

Patent Document 1: WO 2020/218418 A1, “Bipolar plate, battery cell, cell stack, and redox flow battery”
Patent Document 2: JP 2020-087836 “Bipolar plate for battery, method for producing bipolar plate for battery, and redox flow battery”
Patent Document 3: JP 2022-526449 “Porous silicon film material, Manufacture thereof, and Electronic device incorporating the same”
Patent Document 4: JP 2002-015762 “Redox flow battery”
Patent Document 5: JP 2020-184406 “Operation method for redox flow battery, and redox flow battery”
Patent Document 6: WO 2019/087377 “Redox flow battery”
Patent Document 7: Japanese Patent No. 5,585311 “Battery management system”
Patent Document 8: Japanese Patent No. 5916819 “Power energy transportation system”

### SUMMARY OF THE INVENTION

### Problems That the Invention Aims to Solve

While the RF battery of the cell stack structure has the above-described advantages, the RF battery of the cell stack structure has the following drawbacks.
(1) End plates and fasteners are relatively heavy, causing the overall weight of the cell stack to be very large.
(2) The fastening bolts are relatively long and may elongate over time or with temperature changes, reducing the effectiveness of the seals between battery cells and posing a risk of electrolyte leakage.
(3) If a battery cell fails, it is difficult to extract, repair, or replace the failed battery cell on-site from the integrated cell-stack structure.

The present invention has been made in view of these disadvantages of the cell-stack structure, and aims to provide a flow battery, typically an RF battery, that improves on these disadvantages.

### Means for Solving the Problem

In one aspect, the flow battery according to the present invention comprises, on one face, N cell-cartridges (N is an integer of 1 or greater) and a backplane having N or more mounting spaces, the backplane being configured so that the cell-cartridges can be physically attached to and detached from the mounting spaces in a side-by-side arrangement with gaps provided between them.

In the above flow battery, further, the backplane may include, for connection to each of the cell-cartridges, positive-electrolyte feed channels, positive-electrolyte return channels, and couplers provided at each connection point, and negative-electrolyte feed channels, negative-electrolyte return channels, and couplers provided at each connection point, whereby circulation of the positive and negative electrolytes to the cell-cartridges mounted on the backplane may be ensured.

In the above flow battery, further, a rack frame may be provided, and a plurality of the backplanes may be mounted on the rack frame in multiple tiers, wherein positive and negative electrolyte feed connection pipes and positive- and negative-electrolyte return connection pipes mounted on the rack frame and the positive and negative electrolyte feed channels and positive and negative electrolyte return channels mounted on each of the backplanes are respectively connected via couplers, whereby circulation of the positive and negative electrolytes to each backplane may be ensured.

In the above flow battery, the couplers may be couplers provided with an electrolyte-leakage-prevention function, so that the backplane or the cell-cartridges can be replaced without leakage of electrolyte.

In the above flow battery, each cell-cartridge may have any desired number of stacked cells, each cell being formed by stacking, as constituent components, among both-electrode plates, a separator, and a single-electrode plate, at least the both-electrode plates and/or the single-electrode plate together, with one separator, and some or all of the cell-cartridge constituent components may be fixedly bonded to each another.

In the above flow battery, further, a heat-exchange component that performs heat exchange by blowing air into the gaps between the plurality of cell-cartridges may be provided.

In the above flow battery, further, the backplane may be provided with diode-function components connected in parallel to each cell-cartridge so that the diode-function component has its anode connected to the cartridge's negative electrode and its cathode connected to the cartridge's positive electrode, thereby preventing an excessive reverse voltage from being applied to the backplane when a malfunctioning cell-cartridge is removed during operation.

In the above flow battery, further, sensors capable of measuring the voltages of the individual cells constituting the cell-cartridges may be incorporated into the backplane.

In the above-described flow battery, a sensor capable of measuring at least one of a voltage of each cell constituting the cell-cartridge and a flow rate, a temperature, a pressure, or an oxidation-reduction potential of each cell constituting the cell-cartridge may be incorporated in the backplane.

In the above flow battery, further, electrolyte flow-control valves may be incorporated respectively into the positive-electrolyte feed channels and the negative-electrolyte feed channels of the backplane.

In the above flow battery, further, an RF core unit and multiple positive-electrolyte tanks and multiple negative-electrolyte tanks may be provided, and relative to the RF core unit a plurality of backplanes having feed channels and return channels mounted thereon may be provided; by attaching one or more leakage-prevention-function couplers to a set of a positive-electrolyte feed channel and a positive-electrolyte return channel, and attaching one or more leakage-prevention-function couplers to a set of a negative-electrolyte feed channel and a negative-electrolyte return channel, arbitrary numbers of electrolyte tanks and piping may be connected or disconnected via those couplers, enabling increase/decrease of the electrolytes subject to charging/discharging and exchange between charged electrolyte and discharged electrolyte.

In one aspect, the flow battery according to the present invention comprises, on one face, a battery unit that includes a stack having any desired number of cells, each cell being formed by appropriately stacking, as constituent components, among both-electrode plates, a separator and a single-electrode plate, at least the both-electrode plates and/or the single-electrode plate together with one separator, and the both-electrode plates or the single-electrode plate are fixed (by adhesive bonding or welding) and integrated, or adjacent constituent components are fixed (by adhesive bonding or welding) and integrated with each other.

In the above flow battery, the stack may be such that adjacent cells are fixed (by adhesive bonding or welding) to each other and integrated.

In the above flow battery, the cells may be applied to either a battery cell of a cell-stack structure or a cell battery of a cell-cartridge-backplane structure.

### Effect of the Invention

According to the present invention, it is possible to provide a flow battery, typically an RF battery, that compensates for a defect of a cell stack structure and improves the defect.

### BRIEF DESCRIPTION OF THE DRAWINGS

FIG. 1 is a diagram explaining the basic structure of a conventional RF battery.

FIG. 2 shows an example of a cell-cartridge module that constitutes the RF battery according to the first embodiment.

FIG. 3 shows the cell-cartridge modules mounted on a rack frame in four tiers vertically.

FIG. 4 shows a cell-cartridge.

FIGS. 5A and 5B together form an overall view of the RF battery according to this embodiment.

FIG. 6 shows an example of creating a cell-cartridge using a single-electrode plate and both-electrode plates.

FIG. 7 shows an example of the configuration of a both-electrode plate realized using an electrically non-conductive non-transmissive sheet.

FIGS. 8A and 8B together show an electrolyte coupler with a leakage-prevention valve.

FIG. 9 shows the electrical-related structure and wiring diagram of the backplane and the cell-cartridges.

FIG. 10 shows an example in which functions necessary for management and control of the module are incorporated into the backplane of the cartridge module.

FIG. 11 is a block diagram of a multi-sense control communication board incorporated into the backplane.

FIG. 12 shows an example of a system in the RF battery in which the negative-electrolyte tank and the positive-electrolyte tank are separable.

### MODE FOR CARRYING OUT THE INVENTION

Embodiments of the flow battery according to the present invention will be described below in detail with reference to the accompanying drawings, taking an RF battery as an example. In the drawings, the same reference numerals are allotted to the same elements and redundant description is omitted.

### First Embodiment

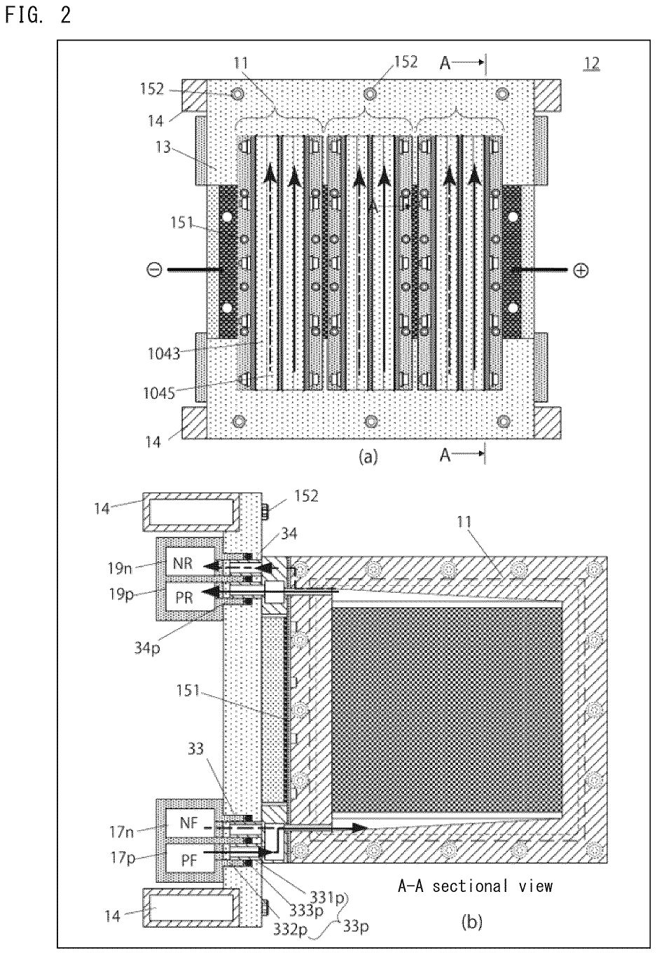

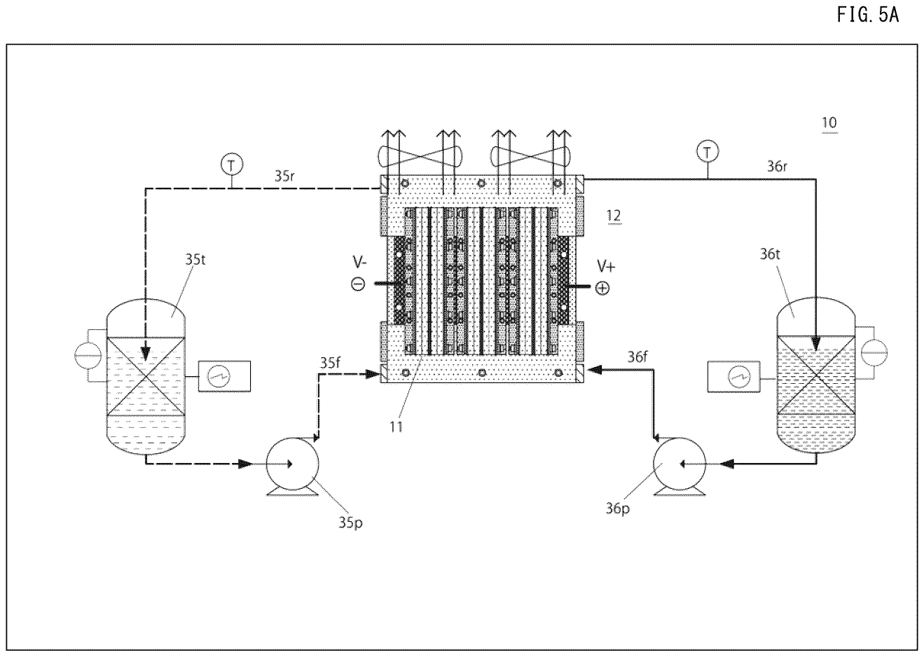

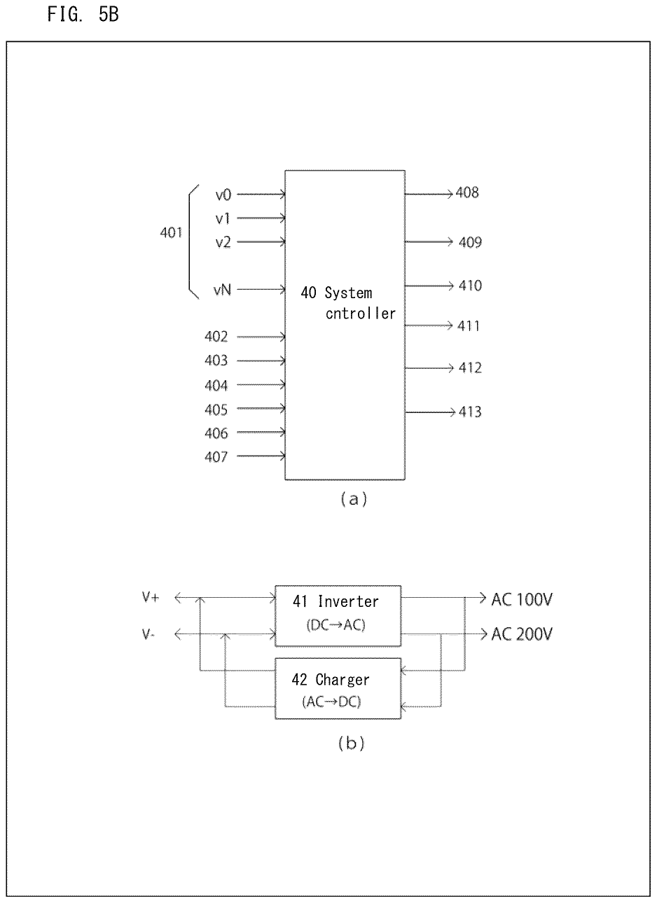

FIG. 2 shows an example of a cell-cartridge module 12 that constitutes the RF battery 10 of the first embodiment (see FIG. 5A). Here, (a) is a front view of the cell-cartridge module, and (b) is the A-A sectional view.

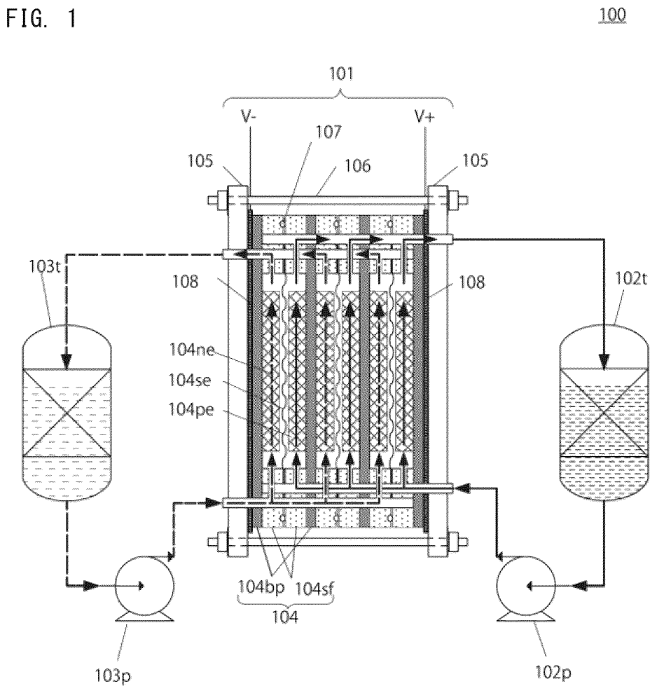

The RF battery 10 of the first embodiment, in terms of implementation form, adopts the cell-cartridge-backplane structure (the structure of the cell-cartridge module 12) in place of the stack structure of the cell stack 101 of the RF battery shown in FIG. 1. Each cell-cartridge 11 is mounted with gaps between them.

Below, the structure of the cell-cartridge module that realizes the cell-cartridge-backplane structure, the detailed structure of the cell-cartridge, and the overall configuration of the RF battery realized by the cell-cartridge module are described.

### (Structure of the Cell-Cartridge Module)

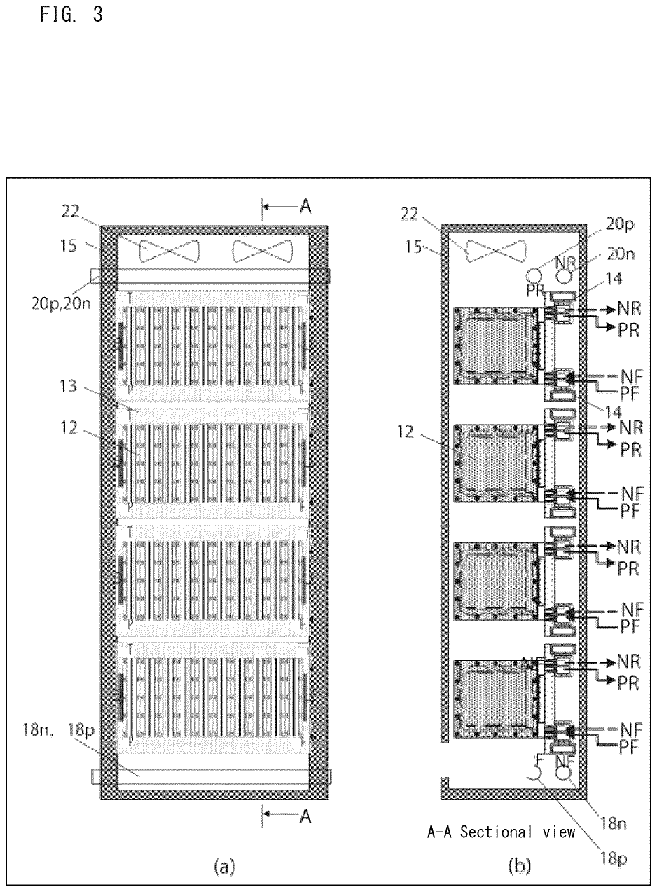

As shown in the front view of FIG. 2(a), three cell-cartridges 11 are attached to the backplane 13 using cartridge fixing bolts 151 in the cell-cartridge module 12. The backplane 13 is attached to a horizontal angle pipe 14 using backplane-fixing bolts 152. The horizontal angle pipe 14 is previously fixed to a rack frame 15 (see FIG. 3). Although the number of cell-cartridges 11 attached to the backplane 13 is three in FIG. 2, it may be any desired number. The mounting area of the backplane 13 may be provided with more mounting spaces than the actual number of cell-cartridges 11.

Each cell-cartridge 11 is provided with electrolyte couplers 33, 34 respectively at the electrolyte inlet and outlet. Electrolyte flowing through the interior of each cell-cartridge 11 is separated into a positive-electrode route and a negative-electrode route. Therefore, elements of the positive-electrode route are denoted with the reference suffix “p” and elements of the negative-electrode route are denoted with the reference suffix “n” for distinction.

The positive electrolyte (shown by a solid line) supplied from tank 36t (see FIG. 5A) is branched at the electrolyte coupler 33p provided per cell-cartridge from the positive-electrolyte feed channel 17p and is supplied to the positive electrodes 1045 of the cells that make up the cell-cartridge. The electrolyte that has reacted at the positive electrode 1045 is merged at the electrolyte coupler 34p into the positive-electrolyte return channel 19p and is returned to tank 36t. The negative-electrolyte is similarly handled (shown by a dashed line).

The electrolyte coupler 33p of the cell-cartridge is provided, on the cell-cartridge 11 side, with a protruding-type detachable coupler (hereinafter referred to as “plug”) 331p, and on the backplane side with a recessed receiving coupler (hereinafter referred to as “socket”) 332p. The plug and socket are connected via an O-ring 333p. The mechanism (plug, socket, and O-ring) of the electrolyte coupler 34p is similar. The plug 331p and socket 332p mechanism allows engagement and disengagement. The mechanisms of the electrolyte couplers 33n and 34n for the negative-electrode route are likewise similar.

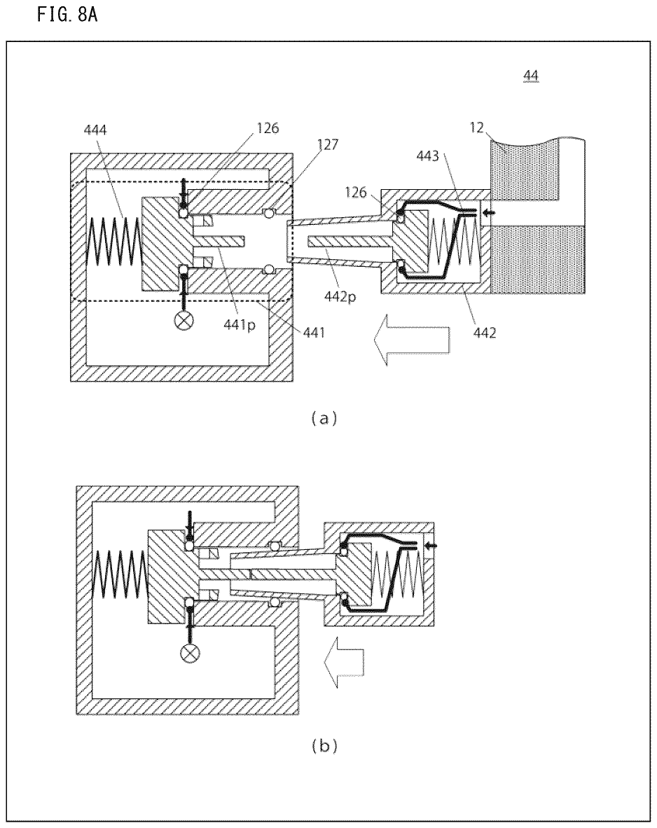

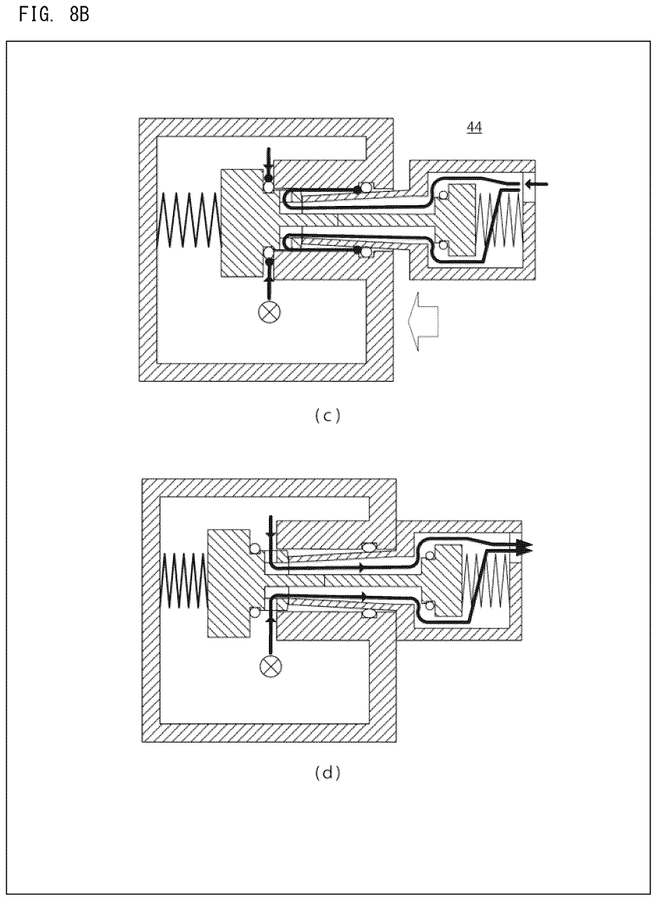

The cell-cartridge 11 is connected to the backplane side via the electrolyte couplers. If the electrolyte couplers are configured as couplers with a liquid-leakage prevention function, then attaching and detaching the cell-cartridge 11 to/from the backplane during operation does not cause electrolyte leakage. The leakage-prevention mechanism of such electrolyte couplers is described in detail with reference to FIGS. 8A and 8B.

Compared with the integrated cell-stack structure shown in FIG. 1, the cell-cartridge modules 12 shown in FIG. 2 have gaps (preferably spaces of 1 to 50 mm) between cell-cartridges and can be mounted to and removed from the backplane 13. As a result, each cell-cartridge 11 can be handled as a unit. That is, because each cell-cartridge unit is compact and lightweight, transportation, installation, replacement, and maintenance become easier. Furthermore, heat generated in each cell-cartridge 11 can be efficiently discharged externally by forced air cooling using the gaps between them. If necessary, warm air can be supplied into these gaps to heat each cell-cartridge 11.

FIG. 3 shows the cell-cartridge modules 12 mounted in four vertical tiers on the rack frame 15. Here, (a) is a front view with the front panel removed, and (b) is the A-A sectional view.

A cooling fan 22 is installed at the upper section of the rack frame 15. In advance, two horizontal angle pipes 14 (upper and lower) in four sets have been attached to the rack frame 15, enabling fixation of four sets of cell-cartridge modules 12.

The symbols shown in (b) are as follows: PF: supply positive electrolyte, PR: return positive electrolyte, NF: supply negative electrolyte, NR: return negative electrolyte.

The positive electrolyte PF from the positive electrolyte supply connecting pipe 18p at the bottom of the rack frame is branched to the positive-electrolyte supply channels 17p of the four cell-cartridge modules 12. The positive electrolyte PR from the positive-electrolyte return channels 19p of the cell-cartridge modules is collected into one and merged into the positive-electrolyte return connecting pipe 20p at the top of the rack frame. Similarly, negative electrolyte NF from the negative-electrolyte supply connecting pipe 18n is branched to the negative-electrolyte supply channels 17n of the respective cell-cartridge modules, and negative electrolyte NR from the negative-electrolyte return channels 19n of the cell-cartridge modules is merged into the negative-electrolyte return connecting pipe 20n.

The above rack frames can be connected together and easily installed in large housings such as containers.

### (Detailed Structure of the Cell-Cartridge)

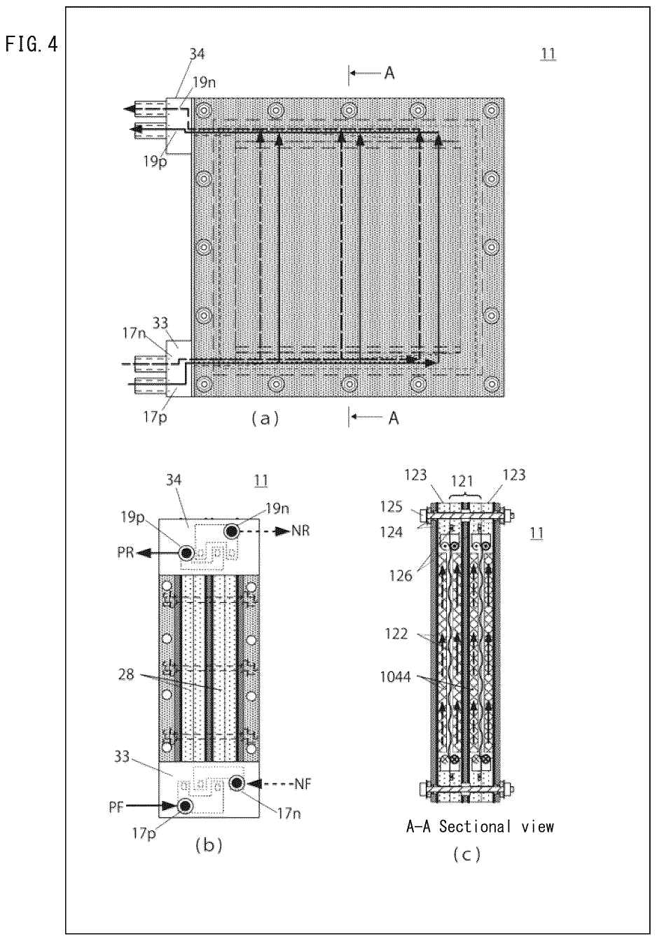

FIG. 4 shows the cell-cartridge 11. Here, (a) is a front view of the cell-cartridge 11, (b) is a left side view, and (c) is the A-A sectional view.

The cell-cartridge 11 can be constructed by stacking an arbitrary number of cells 28. In the illustrated example, as shown in (b), it is composed of two cells 28. This cell-cartridge 11 is formed by a single bipolar electrode plate 121 sandwiched between two separators 122 and two single electrode plates 123, and is tightened by fastening members (insulating bush 124 and fastening screw 125). In general, the cell-cartridge 11 may stack an arbitrary number N of cells; in that case, it comprises N-1 bipolar electrode plates, N separators, and two single electrode plates.

As shown in (a) and (b), the cell-cartridge 11 is provided with two electrolyte couplers 33 and 34 at the lower and upper portions of the cell body. The lower electrolyte coupler 33 is provided with protrusions (plugs) that couple to the positive-electrolyte supply channel 17p and the negative-electrolyte supply channel 17n of the backplane 13, and the upper electrolyte coupler 34 is provided with protrusions (plugs) that couple to the positive-electrolyte return channel 19p and the negative-electrolyte return channel 19n of the backplane 13. By mounting the cell-cartridge to the backplane, electrolyte circulation is ensured.

As shown in (a) and (b), the positive and negative electrolytes sent from the supply channels 17p/17n are supplied to the lower electrolyte coupler 33, distributed to the positive electrodes/negative electrodes of the cells mounted in the cell-cartridge, flow respectively through the positive/negative electrodes, reunite at the upper electrolyte coupler 34, and are discharged to the return channels 19p/19n. The cell-cartridge 11 can thus be attached to and detached from the backplane via the electrolyte couplers 33 and 34.

### (Overall Configuration of the RF Battery)

FIGS. 5A and 5B are overall diagrams of the RF battery according to this embodiment. FIG. 5A shows the battery section. In FIG. 5B, (a) is the control unit and (b) is the power conversion unit.

As shown in FIG. 5A, negative electrolyte in the negative electrolyte tank 35t is delivered by the negative-electrolyte pump 35p, passes through the supply piping 35f to the cartridge modules 12, traverses the cell-cartridges 11, passes through the return piping 35r, and returns to the tank 35t. Similarly, positive electrolyte in the positive electrolyte tank 36t is delivered by the positive-electrolyte pump 36p, passes through the supply piping 36f to the cartridge modules 12, traverses the cell-cartridges 11, passes through the return piping 36r, and returns to the tank 36t.

The control unit (a) in FIG. 5B is constituted by a system controller 40 that controls the operation of the RF battery. The power conversion section (b) is constituted by an inverter (DC-to-AC converter) 41 that converts the battery output to the grid (AC 100 V or 200 V) and a charger (AC-to-DC converter) 42 that charges the battery from the grid.

The system controller 40 controls the inverter 41 and the charger 42 so that, according to demand, the RF battery can be charged from the power grid or supply power to the power grid. Such control can be applied to leveling grid power and uninterruptible power supply functions.

In addition, the system controller 40 monitors various signals and performs various controls. For example, during charging and discharging, the charger 42 or inverter 41 is controlled so that each cell does not enter an overcurrent, overcharge, or overdischarge state. The input monitoring signals include: voltages of respective battery cells (v0˜vN) 401, positive-electrolyte level meter value 402, positive-electrolyte redox potential meter value 403, negative-electrolyte level meter value 404, negative-electrolyte redox potential meter value 405, positive-electrolyte temperature meter value 406, negative-electrolyte temperature meter value 407, and the like. Output control signals include: positive-electrolyte pump control output 408, negative-electrolyte pump control output 409, cooling fan speed control output 410, inverter control output 411, charger control output 412, alarm transmission output 413, and the like.

The technical matters described for the RF battery according to the first embodiment are technical matters common to the second and subsequent embodiments.

### Second Embodiment

### (Configuration)

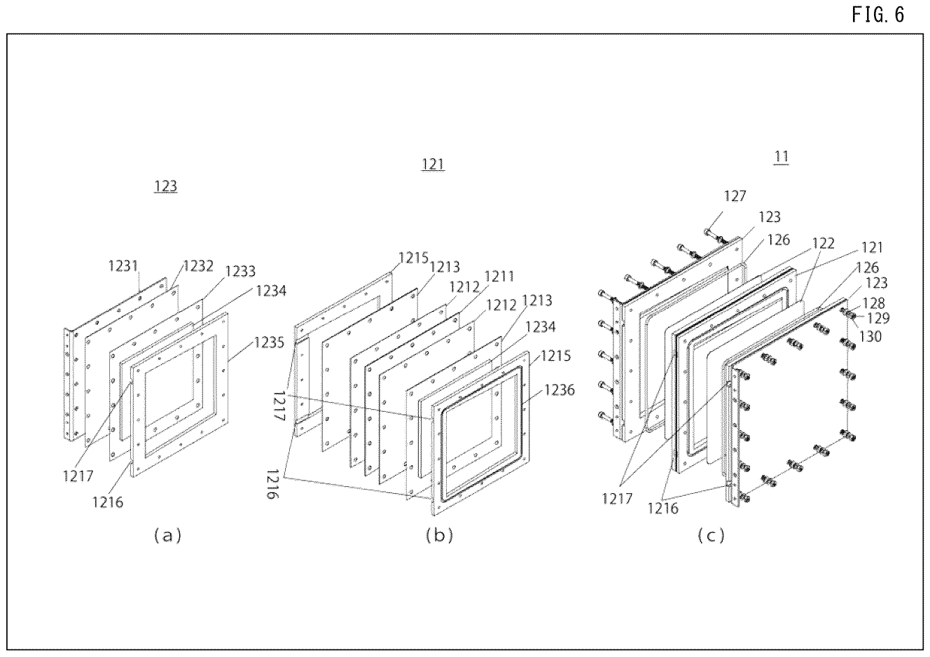

In the second embodiment, a specific example of the cell-cartridge 11 is described. FIG. 6 is a cell-cartridge 11 composed of single electrode plates and bipolar electrode plates. Here, (a) shows the single electrode plate 123, (b) shows the configuration of the bipolar electrode plate 121, and (c) shows the assembled cell-cartridge 11. The electrolyte couplers 33, 34 are omitted from the illustration here.

As shown in (a), the single electrode plate 123 comprises a conductive plate with a flange 1231, conductive seal material 1232, a highly chemical-resistant conductive adhesive 1233, reaction electrode material 1234, and a resin frame plate 1235.

The conductive plate 1231 is formed from a highly conductive metal (copper, aluminum, etc.). The conductive seal material 1232 is formed from a conductive, highly chemical-resistant material (e.g., carbon sheet) that does not permit electrolyte passage. The highly chemical-resistant conductive adhesive 1233 bonds the parts. The reaction electrode material 1234 may be felt, cloth, or the like made of carbon fiber. The resin frame plate 1235 is made of a chemical-resistant resin (polyvinyl chloride, polyethylene, polypropylene, etc.). The resin frame plate 1235 has a frame-shaped configuration with a cut-out portion for receiving the reaction electrode material as shown, and an electrolyte return groove 1217 formed at the upper portion and an electrolyte supply groove 1216 formed at the lower portion. The conductive seal material 1232, the reaction electrode material 1234, and the resin frame plate 1235 are pressed together and adhered by the conductive adhesive 1233.

As shown in (b), both-electrode plate 121 is composed of conductive plate 1211 at the center, conductive sealing material 1212, a chemically highly resistant conductive adhesive 1213, reactive electrode material 1234, and resin frame plate 1215. Each material is the same as described above, but the resin frame plate 1215, in addition to the resin frame plate 1235 of the single electrode, has an O-ring groove 1236 machined as illustrated. As with the single electrode plate 123, in the both-electrode plate 121 the conductive sealing material 1212, the reactive electrode material 1234, and the resin frame plate 1215 are pressed together and bonded by the conductive adhesive 1213.

As shown in (c), the cell-cartridge 11 is composed of one both-electrode plate 121, two single electrode plates 123, two separators 122, and two O-rings 126, and is fastened by fastening screws 127, insulating bushings 128, washers 129, and nuts 130. Typically, an ion-permeable membrane is used for separator 122.

### (Operation)

The interfaces between the single electrode plates 123 and the both-electrode plate 121 that make up the cell-cartridge 11 are sealed by O-rings 126. Therefore, the electrolyte supplied from the electrolyte inlet 1216 is discharged entirely from the electrolyte outlet 1217 without leaking to the exterior of cell 28. Because the cell-cartridge 11 is fastened with a relatively small number of cells 28, the influence of screw loosening or elongation due to aging or temperature changes is small; consequently, the risk of electrolyte leakage from the cells can be reduced.

In the past, a clamping method was used to make face contact connections among the reactive electrode material, the conductive sealing material, and the conductive plate so as to achieve low contact resistance. However, in this embodiment, since these parts are pressure-bonded and adhered using a low-resistance, chemically highly resistant conductive adhesive, it is not necessary to clamp cell 28 with a large force. Because the single electrode plate 123 is supported by a metal conductive plate, the cell-cartridge 11 can maintain sufficient strength against pressure fluctuations and vibrations of the electrolyte.

Also, although not shown, fins may be provided on conductive plate 1231 to improve heat exchange efficiency.

### Third Embodiment

### (Configuration)

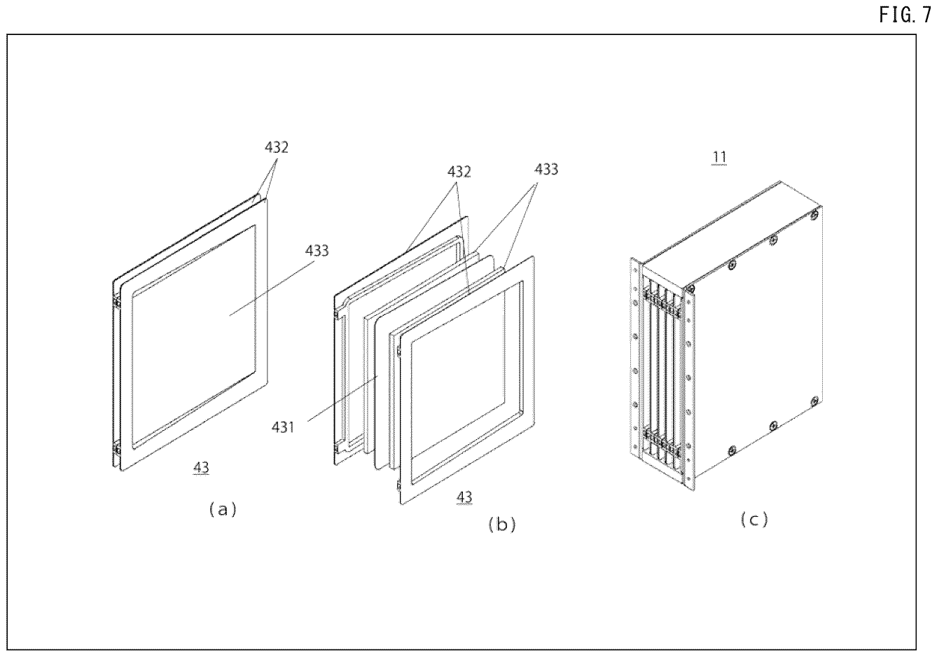

In the third embodiment, another specific example of the cell-cartridge 11 is described. FIG. 7 shows an example configuration of a both-electrode plate 43 realized by a conductive non-permeable sheet 431. Here, (a) is an external view of the both-electrode plate 43, (b) is a configuration diagram of the both-electrode plate 43, and (c) is an example of producing a cell-cartridge using the both-electrode plate 43. As illustrated in (b), the both-electrode plate 43 is composed of a conductive non-permeable sheet 431, two reactive electrode materials 433, and two resin frame sheets 432. Although not shown, a single electrode plate can be readily constituted by a conductive non-permeable sheet 431, one reactive electrode material 433, and one resin frame sheet 432. The cell-cartridge 11 in (c) is formed by stacking the both-electrode plates 43 with a separator interposed therebetween, and the resin frame sheets are bonded by adhesive or welding. In the illustrated example, the cell-cartridge 11 is realized solely by the both-electrode plates 43.

### (Operation)

The both-electrode plate 43 shown in FIG. 7(a) can be realized by using the conductive non-permeable sheet 431 in the configuration shown in (b). The conductive non-permeable sheet 431 is a sheet that prevents penetration of the electrolyte while maintaining high electrical conductivity and possessing mechanical strength. For example, the conductive non-permeable sheet may be made from a sheet-processed low-resistance CFRP (Carbon Fiber Reinforced Plastics).

For the resin of the CFRP, it is desirable to use a chemically highly resistant resin kneaded with a highly conductive filler to achieve low resistance. Further, the reactive electrode bonding portion of the CFRP sheet may be formed in any shape such as corrugated, perforated-pipe shaped, perforated-cardboard shaped, etc. in order to improve electrolyte flow.

By using the conductive non-permeable sheet 431, it is possible to fabricate both-electrode plates or single-electrode plates that keep the joint resistance between reactive electrodes low and have long-term corrosion resistance to the electrolyte.

According to this embodiment, the both-electrode plate has an even simpler configuration than the both-electrode plate 121 shown in FIG. 6(b), reducing the number of parts and enabling the resin frame plate to be formed as a sheet, thereby achieving weight reduction. Also, since the reactive electrode can be bonded at the time the conductive non-permeable sheet is produced, the manufacturing process can be simplified. Furthermore, by bonding around the periphery of the resin frame sheet, the O-rings and screws used in FIG. 6(b) can be eliminated.

### Fourth Embodiment

### (Configuration)

In the electrolyte couplers 33 and 34, by connecting the plug of the cell-cartridge 11 and the socket of the backplane 13 via an electrolyte coupler provided with a leak-prevention valve, the cell-cartridge 11 can be inserted into and removed from the backplane 13 without electrolyte leakage. (See FIG. 2)

FIGS. 8A and 8B show an example of an electrolyte coupler with a leak-prevention valve. Socket 441 is incorporated on the backplane side, and plug 442 is incorporated on the cell-cartridge side.

### (Operation)

The function of the electrolyte coupler with a leak-prevention valve will be explained with reference to FIGS. 8A and 8B. Here, the flow of electrolyte is indicated by thick lines. The black circles at the tips of the thick lines indicate states in which the electrolyte flow is being blocked.

FIG. 8(a) shows the state before inserting the cell-cartridge 12. Due to the pressing forces of coil springs 443 and 444 of both socket 441 and plug 442, the electrolyte in the supply channel and the electrolyte inside the cell-cartridge are both blocked by the leak-prevention O-rings 126, and no leakage occurs. During the process of pushing the cell-cartridge into the backplane 13 in the direction of the arrow in the figure, until the rods (protrusions) 441p and 442p located at the centers of the two elements contact one another, the electrolyte remains non-leaking as in (a).

As shown in (c), when the protrusion 442p of plug 442 contacts the protrusion 441p of the channel's leak-prevention valve while the main bodies are still separated, the O-ring 126 of either the plug or the socket opens (the drawing shows the plug 442 O-ring 126 opened), but leakage is prevented by the coupling-seal O-ring 127.

As shown in (d), when inserted until the main bodies contact, the insertion force overcomes the pressing forces of the coil springs 443 and 444, and both O-rings 126 of the plug 442 and the socket 441 open, so that the electrolyte in the supply channel is delivered to the cell-cartridge.

Conversely, when pulling the cell-cartridge out from the backplane 13, the sequence operates in reverse (d)→(c)→(b)→(a). Even in this case, no electrolyte leakage occurs.

With a cell-cartridge module equipped with the mechanism of this electrolyte coupler, the cell-cartridge can be inserted into and removed from the backplane 13 without electrolyte leakage even while the electrolyte is circulating.

### Fifth Embodiment

### (Configuration)

In the fourth embodiment it was described that even for an operating RF battery, the cell-cartridge 11 can be inserted into and removed from the backplane 13.

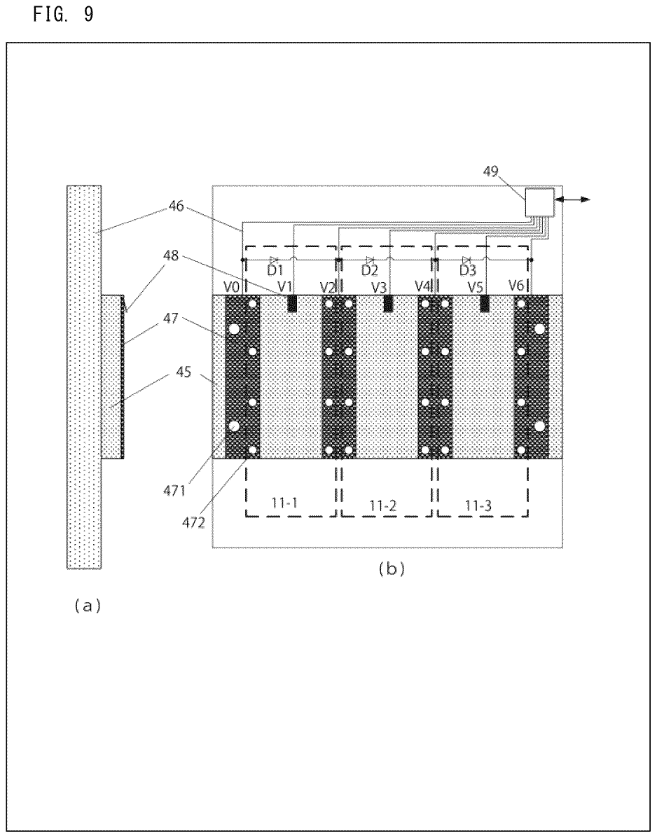

FIG. 9 shows the electrical-related structure and wiring diagram of the backplane 13 and the cell-cartridge 11. The backplane 13 can accommodate three cell-cartridges 11-1, 11-2, and 11-3. As shown in the left-side view in (a), on the backplane 13 an insulating plate 45 is mounted on a base plate 46, and an electrode connection plate (copper plate) 47 is mounted on the insulating plate 45. V0 to V6 are terminal patterns on the backplane; V0, V2, V4, and V6 are connected to the electrode connection plate 47. Further, the potentials V0 to V6 each are sent to the system controller 40 via the voltage measurement communication board 49.

In this example, as shown in the front view (b), the electrode connection plate 47 is arranged to connect the cartridges 11 in series. Note that the electrode connection plate 47 wiring may alternatively be arranged in parallel. The outer electrode connection plates 47 of the backplane 13 are provided with electrode connection screw holes 471 for module connection, which are used to screw in cables for series/parallel connection of cartridge modules.

Also, leaf-spring contacts 48 are mounted on the insulating plate 45; when the cell-cartridge 11 is mounted on the backplane 13 and tightened with the cartridge fixing bolts (screw holes 472), the leaf-spring contacts 48 contact the conductive plates 1211 of the both-electrode plates shown in FIG. 6(b) or the conductive non-permeable sheet 431 of FIG. 7(b) of the cell-cartridge, enabling detection of the electrode potentials.

As illustrated, diodes D1, D2, and D3 are respectively connected between V0-V2, V2-V4, and V4-V6 on the backplane 13.

### (Operation)

When the cell-cartridge 11 is inserted into the backplane 13 and the conductive-plate flange is fastened to the cartridge fixing hole 472 of the backplane 13 with the cartridge fixing bolt 151, the conductive plate 1231 of one electrode plate of the cell-cartridge 11 is coupled to the electrode-connecting plate 47, and the leaf-spring contact 48 contacts the conductive plate 1211 of either electrode plate of the cell-cartridge or the electrically non-conductive (insulating) sheet 431. In this way, the terminals of all cells constituting the cell-cartridges 1-3 mounted in the cartridge module are connected to the V0-V6 terminal pattern on the backplane, allowing the cell-cartridges 1-3 to be connected in series.

Diodes D1-D3 are installed in parallel with the respective cells. Here, assuming the electrolyte is filled so that the left side of every cartridge in the figure is negative and the right side is positive, in each cartridge the cell negative electrode is connected to the diode anode and the cell positive electrode is connected to the diode cathode. In this state a reverse voltage is applied to the diodes, so only a very small leakage current flows.

During operation, if one faulty cell-cartridge is pulled out, in the absence of diodes an excessive reverse voltage may be applied to the corresponding backplane terminal. With D1-D3 present, when such a reverse voltage is applied the diodes conduct forward current, so only on the order of a few volts appears between terminals. This enables safe insertion and removal of cell-cartridges. However, for large cells, removing a cartridge during operation can allow hundreds of amperes to flow, causing sparks, terminal welding, or diode destruction. It is preferable to remove cartridges when the cell's power generation has stopped. Ideal diodes may also be used to improve diode characteristics.

### Sixth Embodiment

The sixth embodiment further describes an example for appropriately maintaining operation of an RF battery during operation and improving safety.

### (Configuration)

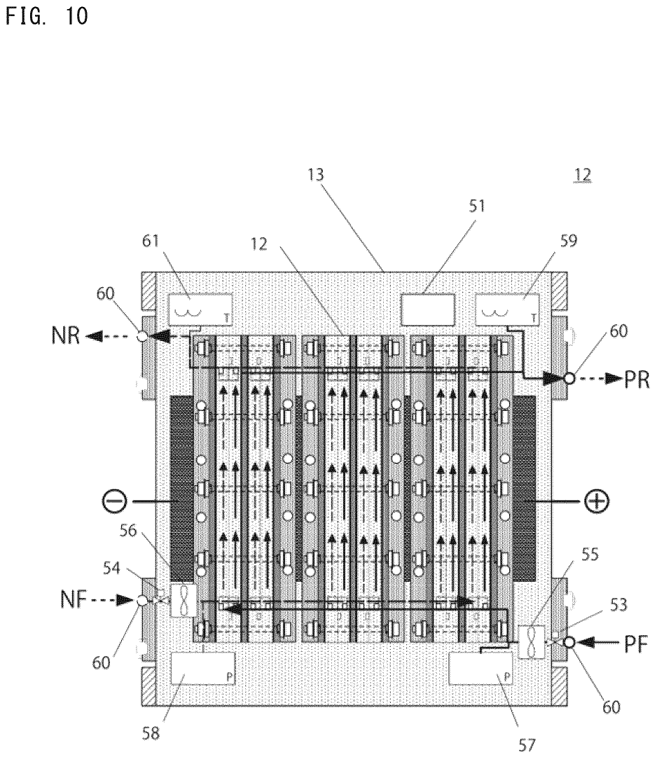

FIG. 10 shows an example in which functions necessary for module management and control are incorporated into the backplane 13 of the RF battery 10. In this example, as controllers for managing the electrolytes, electrolyte flow control valves 53, 54, electrolyte flow meters 55, 56, electrolyte pressure gauges 57, 58, and electrolyte temperature gauges 59, 61 are provided for the positive and negative electrodes, respectively. A multi-sense control communication board 51 is installed to carry out these measurements and controls.

Also, to improve manufacturability and maintainability, connection nipples (a pair of connection fittings with male and female threads) or couplers 60 are attached at the supply/return electrolyte connection points. From the connection nipples/couplers 60 via hoses, as in FIG. 3, connections are made to the rack electrolyte supply/return connection pipes 18p, 18n/20p, 20n.

### (Operation)

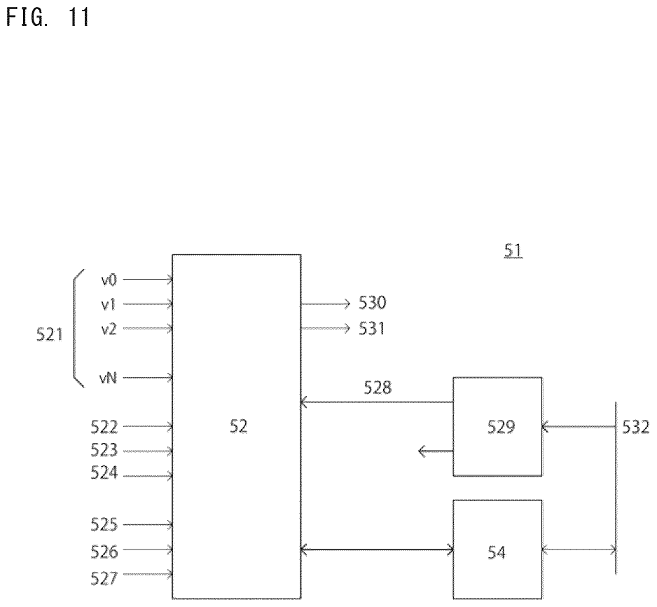

FIG. 11 is a block diagram of the multi-sense control communication board incorporated in the backplane 13. The multi-sense control communication board 51, using a microprocessor 52, has functions to read all cell voltages and the above sensor signals within the backplane, to control the positive/negative electrolyte flow control valves, and to communicate with a higher-level host computer via an isolated communication circuit 54.

Input signals to the microprocessor 52 include each battery-cell voltage (v0-vN) 521, positive-electrolyte pressure gauge reading 522, positive-electrolyte flow meter reading 523, positive-electrolyte temperature reading 524, negative-electrolyte pressure gauge reading 525, negative-electrolyte flow meter reading 526, negative-electrolyte temperature reading 527, and a drive power 528 supplied via an isolated power supply 529 from power source 532, among others. Output signals include positive-electrolyte flow-control valve control output 530 and negative-electrolyte flow-control valve control output 531. Thus, the microprocessor 52 appropriately maintains the negative/positive electrolyte flow rates within the battery cells, measures and manages the pressures of the negative and positive electrolytes, and controls electrolyte temperatures to keep them within target ranges. Further, when replacing a faulty cell-cartridge, closing the positive/negative flow control valves 53, 54 allows stopping the entire module, enabling safe replacement of the cell-cartridge.

The microprocessor 52 performs management and control at the backplane unit level, and a higher-level host computer performs management and control of multiple backplanes.

### Seventh Embodiment

### (Configuration)

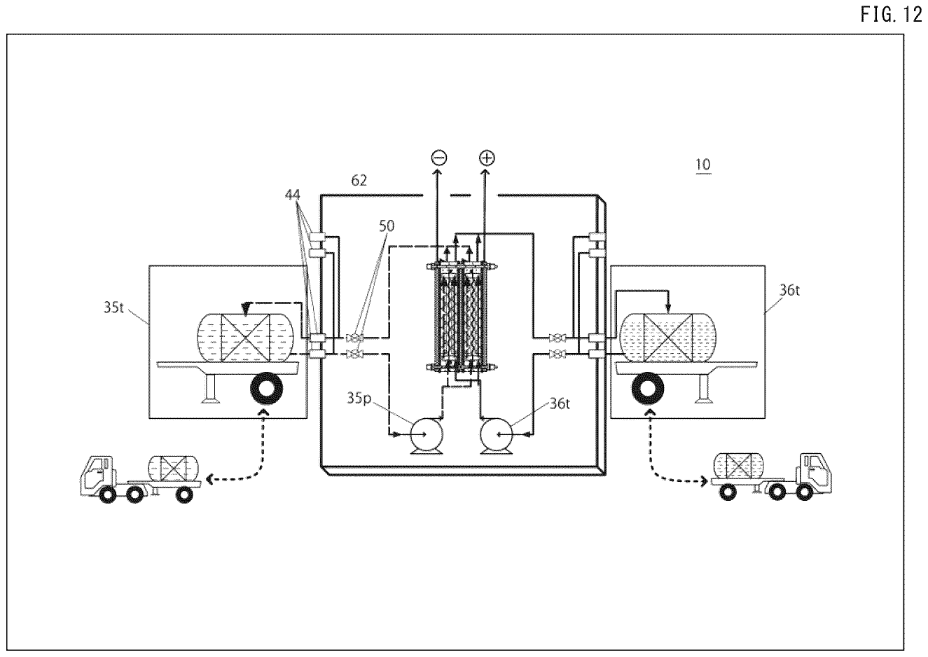

FIG. 12 shows an example of a system in the RF battery 10 in which an andRF core unit 62 is used to make the negative-electrolyte tank 35t and positive-electrolyte tank 36t separable from the RF core unit 62. The RF core unit 62 is a unit composed of multiple cartridge modules or multiple rack frames, feed pumps, piping, and so forth, and has the function of converting electrical energy and chemical energy to and from each other.

The RF core unit 62 and the negative-electrolyte tank 35t and the positive-electrolyte tank 36t are detachably connected, respectively, by one or two or more leak-preventing couplers 44 for a set of positive and negative electrolytes (see FIGS. 8A and 8B). Additionally, shut-off valves 50 for preventing electrolyte outflow during abnormal events may be installed. By providing two or more leak-preventing couplers, even during operation the electrolyte tanks can be replaced without stopping charge/discharge operations.

By making the negative-electrolyte tank 35t and the positive-electrolyte tank 36t separable from the RF core unit 62, electrolyte replacement and transport and increases or decreases in electrolyte capacity become possible. Also, adding or removing RF core units 62 makes it easy to change input/output power.

Conventionally, RF batteries could only be constructed as systems with predetermined power output (W) and maximum stored energy (Wh). In this embodiment, the RF core unit mechanism makes it possible to increase or decrease output and storage capacity as needed, to share capacity between systems, and to perform maintenance without stopping the entire system. By parking many RF core units 62 and large numbers of tanks 35t, 36t, expansion to batteries of very large capacity is also facilitated.

### Advantages and Effects of This Embodiment

According to the cell-cartridge-backplane structure and RF core unit mechanism RF battery of this embodiment, because design, installation, maintenance, and replacement work can be performed at the levels of cell-cartridge, cartridge module, RF core unit, and electrolyte tank, the following advantages and effects can be expected.
(1) With the cell-cartridge structure, weight reduction, part count reduction, and manufacturing process reduction can be achieved compared with the conventional stacked structure, and the following lifecycle effects can be expected as a result.
   (a) At design time, to satisfy desired power conditions of the RF battery (output voltage, output power, stored energy, etc.), it is easy to determine the required numbers of cell-cartridges, cartridge modules, RF core units, the amounts of electrolyte, and the numbers of electrolyte tanks.
   (b) At manufacturing time, cell-cartridges can be standardized, enabling mass production and automation to reduce manufacturing costs. Even for large-scale RF batteries, prefabrication of RF core units and electrolyte tanks can reduce costs and shorten construction schedules.
   (c) At inspection stages, testing and evaluation can be easily performed at the cell-cartridge level, avoiding the large rework (disassembly, repair, assembly, retesting) that conventionally occurred when stack failures arose.
   (d) At installation, installation by cartridge-module units is possible, facilitating installation in confined spaces.
   (e) By stocking cell-cartridges as maintenance parts, rapid replacement of faulty cell-cartridges is possible.
(2) With an RF core unit equipped with multiple leak-preventing couplers, replacement, increase/decrease, and transport of electrolyte tanks during operation become easy.

### Modifications and Others

The RF battery of this embodiment is applicable not only to various redox flow batteries but also to devices that include stack-form cells (for example, fuel cells or electrolytic cells).

For example, in a device having stack-form cells, the stack may comprise any number of cells, and the cells, as constituent components, include two electrode plates, a separator, and a single electrode plate; adjacent such components may be partially or entirely bonded (by adhesive or welding) to integrate them. Furthermore, cells may also be bonded (by adhesive or welding) to each other.

The invention can also be applied to flow batteries that use only one of the positive or negative electrolytes.

Additions, deletions, changes, and improvements relating to this embodiment that are readily made by those skilled in the art fall within the scope of the present invention. The technical scope of the present invention is defined by the description of the appended claims.

### DESCRIPTION OF REFERENCE NUMERALS

10: RF battery, 11: cell-cartridge, 12: cell-cartridge module, 13: backplane, 15: rack frame, 33, 34: electrolyte coupler, 40: system controller, 41: inverter, 42: charger, 44: leakage-prevention coupler, 62: core unit, 100: RF battery, 101: cell stack, 104: each battery cell, 121: bipolar electrode plate, 122: separator, 123: single electrode plate, 124: insulating bushing, 125: fastening screw, 126: O-ring, 127: fastening screw, 431: conductive impermeable sheet, 432: resin frame sheet, 433: reaction electrode material, 441: socket, 442: plug, 1211: conductive plate, 1212: conductive sealing material, 1213: conductive adhesive, 1215: resin frame plate, 1216: electrolyte supply port/supply groove, 1217: electrolyte return port/return groove, 1231: conductive plate, 1232: conductive sealing material, 1233: conductive adhesive, 1234: reaction electrode material, 1235: resin frame plate, 1236: O-ring groove

1-10. (canceled)

11. A flow battery comprising:
N cell-cartridges (where N is an integer of 1 or greater), and
a backplane having at least N mounting spaces, the backplane being configured so that the cell-cartridges can be physically attached to and detached from the mounting spaces in a side-by-side arrangement with gaps provided between the cell-cartridges,
wherein the cell-cartridge includes a plurality of stacked cells.

12. The flow battery according to claim 11, further comprising:
on the backplane, for connection to each of the cell-cartridges, a positive electrolyte feed channel, a positive electrolyte return channel, and couplers provided at the respective connection points; and
a negative-electrolyte feed channel, a negative-electrolyte return channel, and couplers provided at the respective connection points,
whereby circulation of positive and negative electrolytes to and from the cell-cartridges mounted on the backplane is ensured.

13. The flow battery according to claim 11, further comprising:
a rack frame,
wherein a plurality of the backplane are mounted in multiple stages on the rack frame, and wherein positive and negative electrolyte feed connection pipes and positive and negative electrolyte return connection pipes mounted on the rack frame are respectively connected to the positive and negative electrolyte feed and return channels mounted on each backplane via couplers, so that circulation of positive and negative electrolytes to and from each backplane is ensured.

14. The flow battery according to claim 12,
wherein the couplers are couplers with an electrolyte-leakage-prevention function, thereby allowing exchange of the backplane or the cell-cartridges without electrolyte leakage.

15. The flow battery according to claim 11,
wherein each cell is formed by stacking, as constituent components, at least both-electrode plates and/or a single-electrode plate, along with one separator, and
some or all of the cell-cartridge constituent components are fixedly bonded to one another.

16. The flow battery according to claim 11, further comprising:
heat-exchange components that blow air into the gaps between the cell-cartridges for heat exchange.

17. The flow battery according to claim 11,
wherein the backplane includes diode-function components connected in parallel for each cell-cartridge so that the cartridge negative electrode functions as an anode and the cartridge positive electrode functions as a cathode, thereby preventing excessive reverse voltage from being applied to the backplane when a cell-cartridge fails and is removed during operation.

18. The flow battery according to claim 11,
wherein the backplane incorporates sensors capable of measuring at least one of: the voltage of each cell constituting a cell-cartridge; and the flow rate, temperature, pressure, or redox potential of the positive and negative electrolytes.

19. The flow battery according to claim 12,
wherein the positive electrolyte feed channel and the negative-electrolyte feed channel of the backplane each incorporate an electrolyte flow control valve.

20. The flow battery of according to claim 11, further comprising:
an RF core unit and multiple positive electrolyte tanks and multiple negative-electrolyte tanks,
wherein the backplanes are mounted in multiple stages on the RF core unit with feed and return channels attached, and
wherein for each pair of positive electrolyte feed channel and positive electrolyte return channel a set of one or more leakage-preventing couplers is provided, and for each pair of negative-electrolyte feed channel and negative-electrolyte return channel a set of one or more leakage-preventing couplers is provided, such that arbitrary numbers of electrolyte tanks and piping can be connected to or disconnected from the system via these couplers, enabling increase, decrease, or exchange of electrolytes subject to charge/discharge.
